(19) United States
(12) Patent Application Publication
(10) Pub. No.: US 2012/0145531 A1
(43) Pub. Date: Jun. 14, 2012

(54) Apparatus of extracting aromatic compounds from plants using a solvent in sub-zero temperature and process thereof

(76) Inventors: Kai Lin, Xiamen (CN); Hongliang Lu, Xiamen (CN); Pengfei Ma, Xiamen (CN)

(21) Appl. No.: 13/372,506

(22) Filed: Feb. 14, 2012

Related U.S. Application Data
(62) Division of application No. 12/571,413, filed on Sep. 30, 2009.

(51) Int. Cl. B01D 3/40

(52) U.S. Cl. 203/42

(57) ABSTRACT

An extracting process including adding powder into a first flask in a first cooling bath maintained at a temperature; adding solvent into the first flask and sealing the first flask so that the solvent dissolves the predetermined powder to form a homogeneous solution; removing the first flask; and connecting the first flask to a first one of second flasks, interconnecting the second flasks, and connecting a third flask to the last second flask wherein a quantity of aromatic compounds absorbent fluid is contained in each second flask which is placed in a second cooling bath maintained at the temperature, the third flask is placed in a third cooling bath maintained at another temperature, the solution evaporates to flow vaporized aromatic compounds to the second flasks for absorption by the aromatic compounds absorbent fluid, and the vaporized solvent reaches the third flask to be condensed and collected.

### CROSS-REFERENCE TO RELATED APPLICATIONS

This application is a divisional of U.S. patent application Ser. No. 12/571,413, filed Sep. 30, 2009.

### BACKGROUND OF THE INVENTION

1. Field of the Invention

The invention relates to extractions and more particularly to an apparatus of extracting aromatic compounds from odorous plants using a solvent in a condition of low temperature (e.g., in a range of −10° C. to 0° C.) with the solvent being collected at another low temperature (e.g., in a range of −20° C. to 0° C.) for recycle and process thereof.

2. Description of Related Art

Extractions, distillations, etc. have been used for obtaining fragrant oils and compounds from odorous raw materials (e.g., herbs). These conventional processes are disadvantageous due to low efficiency, high energy consumption, and high solvent consumption.

Recently, a number of techniques such as SBE (semi-biological extraction), MAE (microwave accelerated extraction), supercritical fluid extraction, ultrasonic extraction, and centrifugal separation have been devised. Solvents such as alcohol, water, liquid carbon dioxide, petroleum ether, methyl dichloride, and ethyl acetate are typically used in the extraction.

However, a number of disadvantages have been found in above typical processes. For example, obtained aromatic compounds have been damaged in the process due to high temperature, high atmospheric pressure, and toxic compounds of solvent. To the worse, the obtained aromatic compounds may contain toxic compounds which are very difficult of removing. Thus, a need for improvement exists.

### SUMMARY OF THE INVENTION

It is therefore one object of the invention to provide an extracting process comprising the steps of: (a) adding a predetermined weight of a predetermined powder into a first flask in a first cooling bath maintained at a first predetermined temperature; (b) adding a predetermined weight of solvent into the first flask and sealing the first flask so that the solvent dissolves the predetermined powder to form a homogeneous solution after a predetermined period of time; (c) removing the first flask from the first cooling bath; and (d) connecting the first flask to a first one of a plurality of second flasks, interconnecting the second flasks, and connecting a third flask to the last one of the second flasks wherein a quantity of aromatic compounds absorbent fluid is contained in each of the second flasks, each of the second flasks is placed in a second cooling bath maintained at the first predetermined temperature, the third flask is placed in a third cooling bath maintained at a second predetermined temperature, the solution evaporates to flow vaporized aromatic compounds thereof to the second flasks for absorption by the aromatic compounds absorbent fluid, and the vaporized solvent of the solution reaches the third flask to be condensed and collected.

The above and other objects, features and advantages of the invention will become apparent from the following detailed description taken with the accompanying drawings.

### BRIEF DESCRIPTION OF THE DRAWINGS

FIG. 1 is a side elevation of a bath with a first flask disposed therein in which coolant is contained in the bath and the first flask contains a raw material dissolved by a solvent showing a portion of an extracting apparatus according to the invention;

FIG. 2 is a side elevation of an arrangement of the first flask, a plurality of second flasks for absorbing aromatic compounds, and a third flask for collecting solvent for recycle showing the remaining portions of the extracting apparatus according to the invention; and

FIG. 3 is a flowchart depicting an extracting process for use with the extracting apparatus for obtaining aromatic compounds according to the invention.

### DETAILED DESCRIPTION OF THE INVENTION

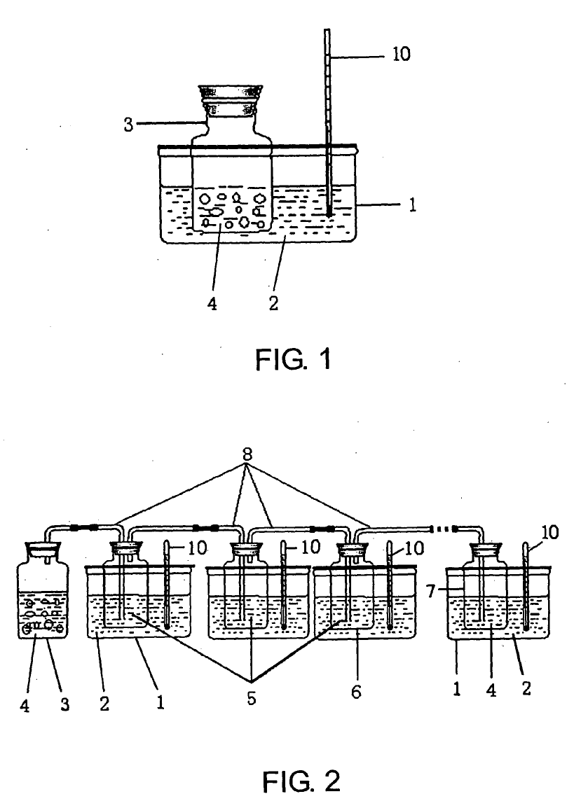

Referring to FIGS. 1 and 2, an apparatus of extracting aromatic compounds from plants using a solvent in sub-zero temperature in accordance with the invention is shown. The apparatus comprises the following components as discussed in detail below.

As shown in FIG. 1, a first flask 3 containing a raw material to be extracted is provided in a bath 1. A quantity of coolant 2 is contained in the bath 1. That is, the bath 1 is a cooling bath. A thermometer 10 is mounted in the bath 1. The bath 1 is cooled by the coolant 2. The bath 1 is maintained in a temperature range of −10° C. to 0° C. and is under standard atmospheric pressure. A predetermined amount of solvent 4 is added into the first flask 3 prior to sealing the first flask 3. Preferably, the solvent 4 is odorless and has a low boiling point (e.g., in a temperature range of −5° C. to 10° C.), i.e., being easy to evaporate. The solvent 4 can dissolve the raw material in the first flask 3 to form a homogeneous solution after a predetermined period of time.

As shown in FIG. 2, the first flask 3 has been removed from the bath 1 shown in FIG. 1. The first flask 3 is connected to a first one of a plurality of (e.g., three) second flasks 6 by piping 8. The second flasks 6 are also connected together by piping 8. Each second flask 6 is placed in a bath 1 containing coolant 2. The baths 1 are maintained in a temperature range of −10° C. to 0° C. Each second flask 6 contains a quantity of aromatic compounds absorbent fluid 5. An outlet of a section of the piping 8 in the second flask 6 should be inserted into the aromatic compounds absorbent fluid 5 and an inlet thereof should be disposed above the aromatic compounds absorbent fluid 5. A thermometer 10 is mounted in each bath 1. The first flask 3 and the baths 1 are placed in a condition of room temperature (e.g., in a temperature range of 20° C. to 25° C.) and are under standard atmospheric pressure. Hence, the solution in the first flask 3 quickly evaporates by absorbing heat. The vaporized aromatic compounds and the vaporized solvent 4 of the solution pass through the second flasks 6 sequentially. The vaporized aromatic compounds of the solution, based on different boiling points of its components, are absorbed by the aromatic compounds absorbent fluid 5. Preferably, the vaporized solvent 4 generated by evaporating the solution substantially does not react with the aromatic compounds absorbent fluid 5. The collected aromatic compounds can be used as essential oils, perfumery, medicinal, or the like.

A third flask 7 is connected to the last one of the second flasks 6 by the piping 8. The third flask 7 is placed in a bath 1 with a quantity of coolant 2 contained therein. A thermometer 10 is mounted in the bath 1. The bath 1 is maintained in a predetermined low temperature (e.g., in a temperature range of −20° C. to 0° C.) and is under standard atmospheric pressure.

The vaporized solvent 4 of the solution finally reaches the third flask 7. The vaporized solvent 4 of the solution is cooled again to be collected in the third flask 7 in the form of liquid. The liquid solvent 4 can be recycled for future use.

Preferably, the thermometer 10 can measure a temperature range of −20° C. to 60° C. Further, temperatures of the baths 1 not including the rightmost bath 1 in FIG. 2 are not required to be the same.

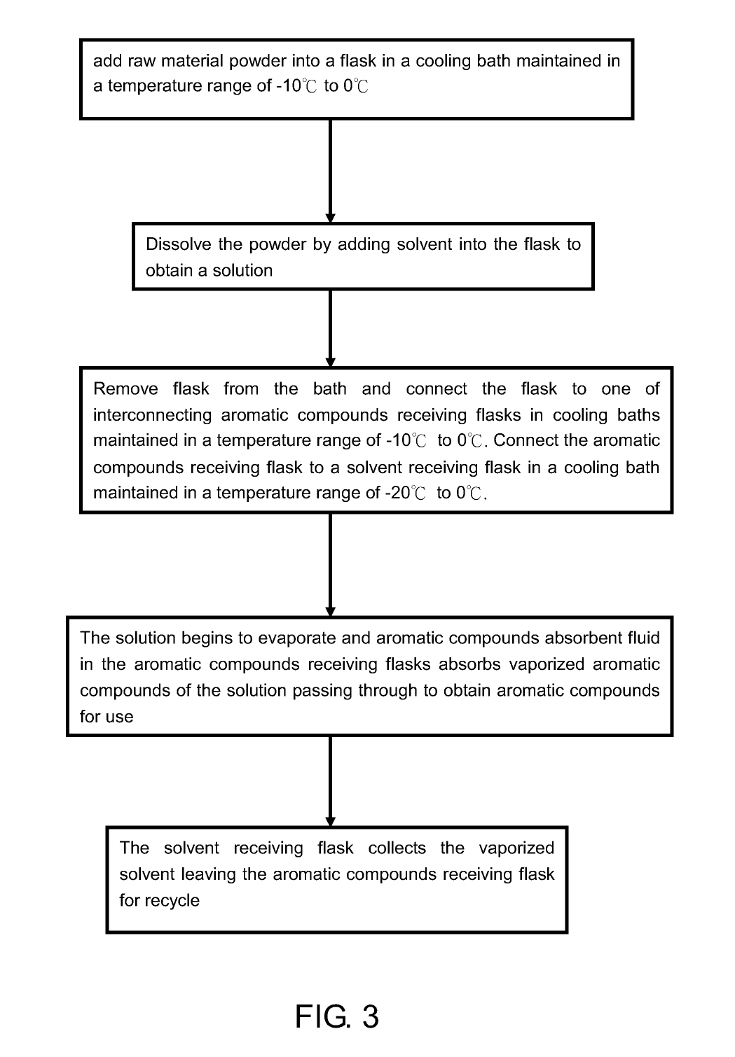

Referring to FIG. 3 in conjunction with FIGS. 1 and 2, a flowchart depicting a process of extracting aromatic compounds from plants using a solvent in sub-zero temperature in accordance with the invention is illustrated.

As shown in FIG. 1, add about 30 g of honeysuckle powder into a first flask 3 in a bath 1. A quantity of coolant 2 is contained in the bath 1. A thermometer 10 is mounted in the bath 1. The bath 1 is cooled by the coolant 2. The bath 1 is maintained in a temperature range of −10° C. to 0° C. and is under standard atmospheric pressure. Next, add about 150 g of a selected solvent 4 into the first flask 3 and seal the first flask 3. The solvent 4 begins to dissolve the honeysuckle powder. A homogeneous solution is formed in the first flask 3 after about 15 hours. These are first and second steps of the process. Note that a person should watch the thermometer 10 regularly since the temperature of the bath 1 may increase as the first and second steps evolve. Further, the person should add coolant 2 into the bath 1 at any time in order to maintain the bath 1 at the temperature range of −10° C. to 0° C.

As shown in FIG. 2, the first flask 3 has been removed from the bath 1 shown in FIG. 1. Connect the first flask 3 to a first one of a plurality of (e.g., three) second flasks 6 by piping 8. The second flasks 6 are also connected together by the piping 8. Each second flask 6 is placed in a bath 1 containing coolant 2. The baths 1 are maintained in a temperature range of −10° C. to 0° C. Each second flask 6 contains a quantity of aromatic compounds absorbent fluid 5. A thermometer 10 is mounted in each bath 1. The first flask 3 and the baths 1 are placed in a condition of room temperature (e.g., in a temperature range of 20° C. to 25° C.) and are under standard atmospheric pressure. Hence, the solution in the first flask 3 quickly evaporates by absorbing heat. The vaporized aromatic compounds and the vaporized solvent 4 of the solution pass through the second flasks 6 sequentially. The vaporized aromatic compounds of the solution, based on different boiling points of its components, are absorbed by the aromatic compounds absorbent fluid 5. The collected aromatic compounds can be used as essential oils, perfumery, medicinal, or the like. These are third and fourth steps of the process. Note that a person should watch the thermometer 10 regularly since the temperature of each bath 1 may increase as the third and fourth steps evolve. Further, the person should add coolant 2 into any baths 1 at any time in order to maintain the baths 1 at the temperature range of −10° C. to 0° C.

The vaporized solvent 4 of the solution finally reaches a third flask 7 which is connected to the last one of the second flasks 6 by the piping 8. The third flask 7 is placed in a bath 1 with a quantity of coolant 2 contained therein. A thermometer 10 is mounted in the bath 1. The bath 1 is maintained in a predetermined low temperature (e.g., in a temperature range of −20° C. to 0° C.) and is under standard atmospheric pressure. The vaporized solvent 4 of the solution is cooled again to be collected in the third flask 7. The liquid solvent 4 can be recycled for future use. This is the fifth step of the process.

While the invention has been described in terms of preferred embodiments, those skilled in the art will recognize that the invention can be practiced with modifications within the spirit and scope of the appended claims.

What is claimed is:

1. An extracting process comprising the steps of:
(a) adding a predetermined weight of a predetermined powder into a first flask in a first cooling bath maintained at a first predetermined temperature;
(b) adding a predetermined weight of solvent into the first flask and sealing the first flask so that the solvent dissolves the predetermined powder to form a homogeneous solution after a predetermined period of time;
(c) removing the first flask from the first cooling bath; and
(d) connecting the first flask to a first one of a plurality of second flasks, interconnecting the second flasks, and connecting a third flask to the last one of the second flasks wherein a quantity of aromatic compounds absorbent fluid is contained in each of the second flasks, each of the second flasks is placed in a second cooling bath maintained at the first predetermined temperature, the third flask is placed in a third cooling bath maintained at a second predetermined temperature, the solution evaporates to flow vaporized aromatic compounds thereof to the second flasks for absorption by the aromatic compounds absorbent fluid, and the vaporized solvent of the solution reaches the third flask to be condensed and collected.

2. The extracting process of claim 1, wherein the first predetermined temperature is in a range of −10° C. to 0° C.

3. The extracting process of claim 1, wherein the second predetermined temperatures is in a range of −20° C. to 0° C.

4. The extracting process of claim 1, wherein the solvent has a boiling point in a temperature range of −5° C. to 10° C.

5. The extracting process of claim 1, wherein the vaporized solvent of the solution substantially does not react with the aromatic compounds absorbent fluid.
